(19) United States
(12) Patent Application Publication
(10) Pub. No.: US 2007/0236756 A1
(43) Pub. Date: Oct. 11, 2007

(54) Image Reading Apparatus

(75) Inventor: Hiroshi Yamaguchi, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/690,210

(22) Filed: Mar. 23, 2007

(30) Foreign Application Priority Data
Mar. 23, 2006 (JP) 2006-081516

(51) Int. Cl. H04N 1/04

(52) U.S. Cl. 358/498

(57) ABSTRACT

To provide an image reading apparatus that can be reduced in size in the width direction by making common an ADF conveying reading area and an FBS reading area. An image reading apparatus includes a platen glass having a common reading area in which ADF scanning and FBS operation are configured to be performed.

### CROSS REFERENCE TO RELATED APPLICATION

This application claims priority from Japanese Patent Application No. 2006-081516, filed on Mar. 23, 2006, the entire subject matter of which is incorporated herein by reference.

### FIELD

Aspects of the present invention relate to an image reading apparatus having a function of reading the image of an original to be conveyed opposite an ADF (automatic document feeder) conveying reading area (ADF scanning operation), and a function of reading the image of the stationary original placed in an FBS (flat bed scanner) reading area (stationary document FBS operation).

### BACKGROUND

Conventionally, an image reading apparatus for reading image data of an original using an image sensor such as a CIS (Contact Image Sensor) or a CCD (Charge Coupled Device) has been known. This kind of known image reading apparatus has an ADF scanning operation for reading the image of the original in a process of conveying the original to an ADF conveying reading area as defined on a platen glass using an original document feeder and an FBS operation for reading the stationary original placed in an FBS (flat bed scanner) reading area as defined on the platen glass. Japanese patent publications JP-A-6-141143 and JP-A-10-56541 each illustrate such an image reading apparatus.

FIG. 7 illustrates a known document feeder 110. As shown in FIG. 7, the document feeder 110 has an ADF (Auto Document Feeder: automatic original conveying mechanism) 90 and a sheet feeder 91.

The sheet feeder 91 is formed with a suction chute 93 next to a paper feed tray 92 for stacking the originals. A suction roller 94, a suction nip 95, a separation roller 96 and a separation nip 97 are disposed in the sheet feeder 91.

The suction roller 94 is disposed rotatably on a guide plane under the suction chute 93. The suction nip 95 is disposed to make contact with or separate from the suction roller 94 on a guide plane above the suction chute 93 at a position opposite the suction roller 94, and urged by a spring member to be pressed against the suction roller 94. The originals set on the paper feed tray 92 are urged toward the suction roller 94 by the suction nip 95. The original at the lowest position pressed against the suction roller 94 is fed in the paper feed direction by the rotation of the suction roller 94.

The separation roller 96 is disposed rotatably on the guide plane under the suction chute 93 away from the suction roller 94 in the paper feed direction. The separation nip 97 is disposed to make contact with or separate from the separation roller 96 on the guide plane above the suction chute 93 at a position opposite the separation roller 96, and urged by a spring member to be pressed against the separation roller 96. The original fed by the suction roller 94 is nipped between the separation roller 96 and the separation nip 97 and fed to a conveying passage 98 by the rotation of the separation roller 96.

The ADF 90 has a conveying roller 99, the pinch rollers 100a, 100b and 100c disposed around the conveying roller 99, and the conveying passage 98 as shown in FIG. 7. The conveying passage 98 is formed on the downstream side of the suction chute 93, and formed with a U-shaped cross section. Along the conveying passage 98, the pinch rollers 100a, 100b and 100c are disposed at appropriate intervals from the upstream side to surround the conveying roller 99.

A partitioning member 105 extending in a depth direction of the apparatus is provided on the upper surface of a platen glass 102. The upper surface of the platen glass 102 is partitioned into an ADF conveying reading area 106 and an FBS reading area 107 by the partitioning member 105. Also, a pickup member 108 for picking up the top end of the conveyed original is provided on the downstream side of the ADF conveying reading area 106 in the conveying direction.

When the image is read in an ADF scanning operation using such a document feeder 110, the image reading unit 103 is firstly moved from a home position P1 set under the partitioning member 105 to a position P2 set under the ADF conveying reading area 106, and waits at the position P2, as shown in FIGS. 8A and 8B.

If the original fed from the paper feed tray 92 by the sheet feeder 91 is fed onto the conveying passage 98, the original is conveyed by the conveying roller 99 and the pinch roller 100a. The conveyed original is guided with the top end of the original by a guide member 101 provided above the ADF conveying reading area 106 and the guide plane 105a of the partitioning member 105, and conveyed onto the ADF conveying reading area 106. In the conveying process, the image of the original passing the ADF conveying reading area 106 is read by the image reading unit 103 waiting at the position P2 (see FIG. 8) under the ADF conveying reading area 106.

The original after reading is guided with its top end to the side of the upper conveying roller 99 along a guide plane 108a of the pickup member 108 and returned to the conveying passage 98. And the original is U-turned and conveyed along the conveying passage 98 by the conveying roller 99 and the pinch rollers 100b and 100c, and finally output into a paper output tray 104 disposed above the paper feed tray 92. The image reading unit 103 is returned to the home position P1 (see FIG. 8) after reading the image of the original in the ADF conveying reading area 106.

On the other hand, when the image of the original is read in an FBS operation, the image reading unit 103 is moved horizontally along the bottom surface of the FBS reading area 107 from the home position P1 in an opposite direction away from the position P2, as shown in FIG. 8C. At this time, the image reading unit 103 is moved while being exposed to the FBS reading area 107. Thereby, the reading face of the original is scanned to read the image of the stationary original. In this case, the image reading unit 103 is returned to the home position P1 after reading the image of the original in the FBS reading area 107.

The width of the image reading apparatus depends on the width of the ADF conveying reading area 106 and the FBS reading area 107. In the case where two reading areas 106 and 107 are provided independently and separately, as shown in FIG. 7, the width of the image reading apparatus is determined in view of the width of each of the separate reading areas 106 and 107 and the partitioning member 105.

### SUMMARY

Aspects of the present invention may provide an image reading apparatus including a platen glass having a common reading area in which ADF scanning and FBS operation are configured to be performed.

Aspects of the present invention may provide an image scanning method, including using a first area of a platen glass for both automatic document feeder scanning and stationary document flat bed scanning; and using a second area of the platen glass for stationary flat bed scanning.

Aspects of the present invention may provide an image reading apparatus including a platen glass, an image reader positioned under the platen glass, and a circuit configured to control a motor to hold the image reader at a fixed position under a first area of the platen glass during ADF scanning, and to move the image reader across said first area during stationary document flat bed scanning.

Other aspects and features may become apparent to persons of ordinary skill in the art from the following detailed description of the invention and the accompanying drawings.

### BRIEF DESCRIPTION OF THE DRAWINGS

FIG. 1 is a perspective view showing the external configuration of the multi-function machine 1 according to an illustrative embodiment of the present invention in a state where a cover is closed.

FIG. 2 is a perspective view showing the external configuration of the multi-function machine 1 according to the illustrative embodiment of the invention in a state where the cover is opened.

FIG. 3 is a block diagram showing the configuration of the control unit in the multi-function machine according to aspects of the invention.

FIG. 4 is a partial cross-sectional view showing an ADF.

FIG. 5 is a cross-sectional view showing a scanner unit.

FIG. 6 is a plan view showing a reading section.

FIG. 7 is a typical view showing a schematic constitution of a conventional r.

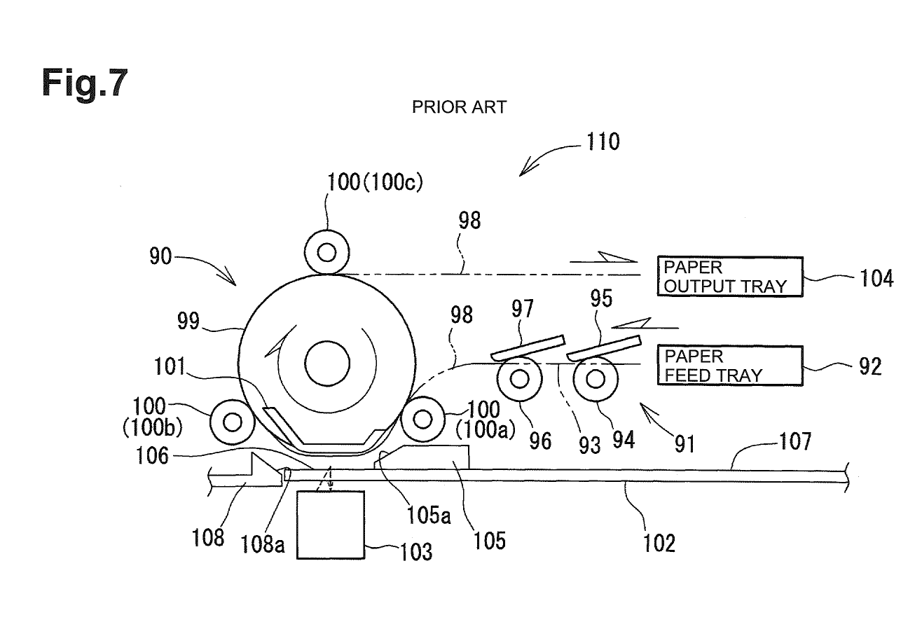

FIG. 8 is a typical view for explaining the operation of a conventional image reading unit.

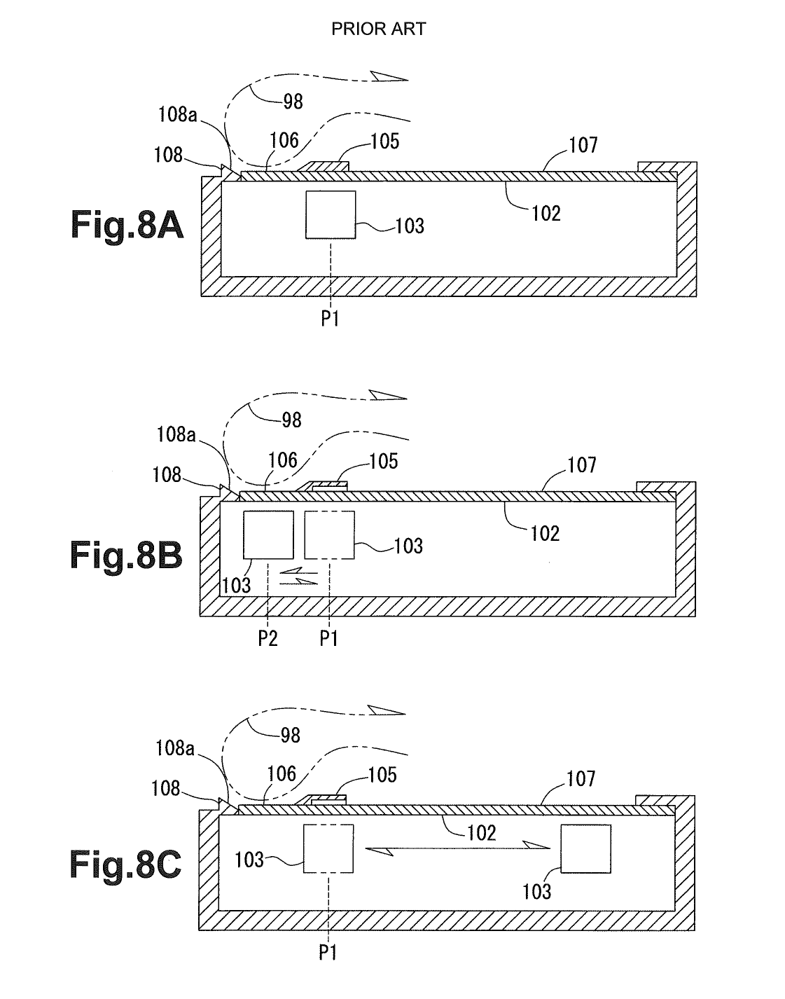

### DETAILED DESCRIPTION

Aspects of the present invention will be described below with reference to the accompanying drawings. The following aspects are only illustrative, and various modifications may be appropriately made without departing from the spirit or scope of the invention.

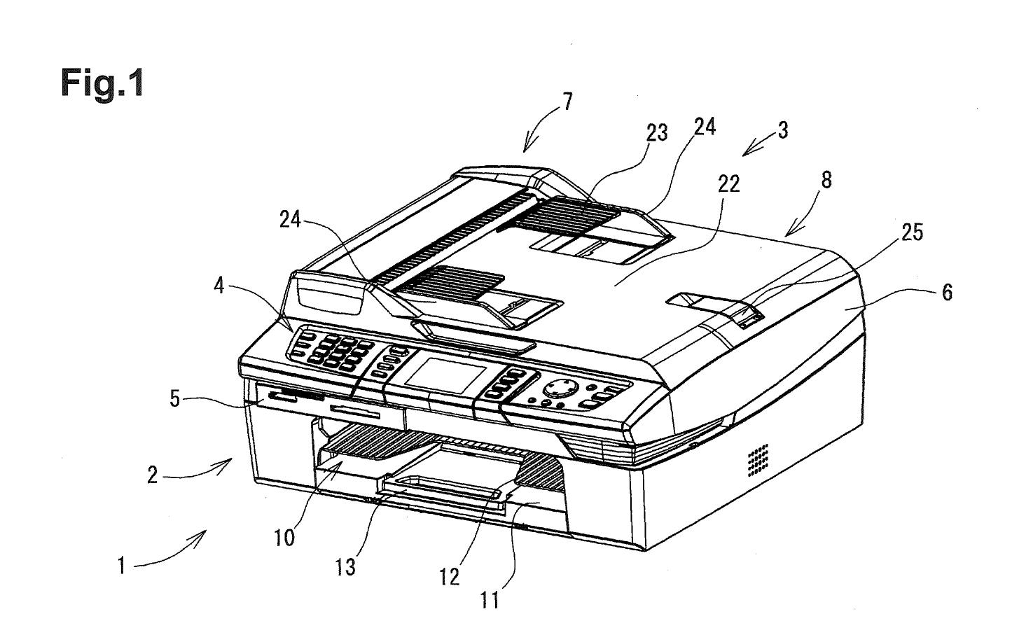

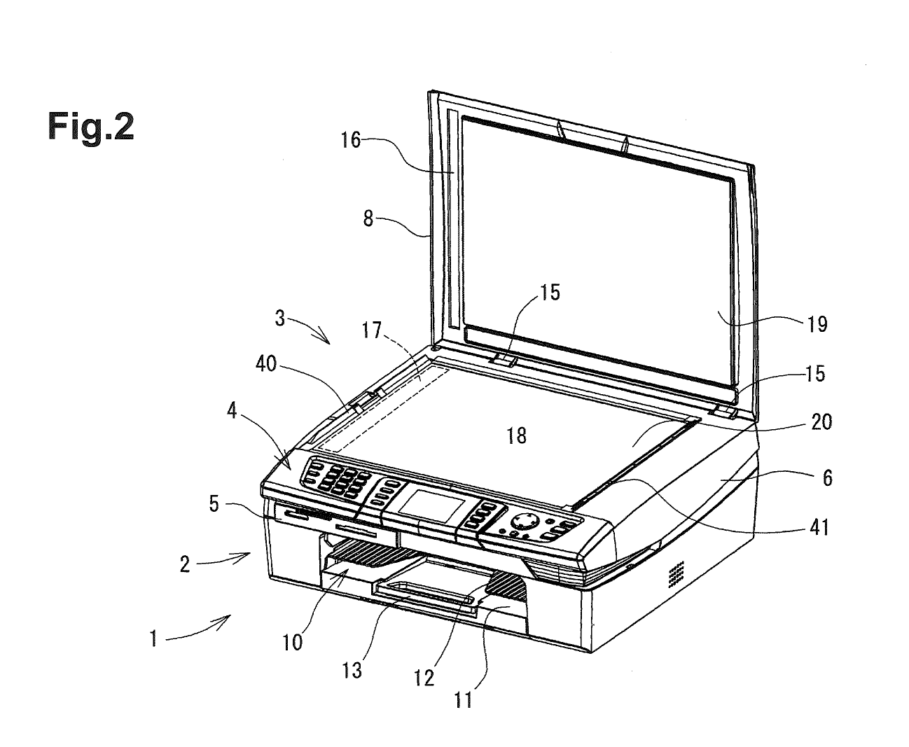

FIGS. 1 and 2 are perspective views showing the external configuration of a multi-function machine 1 according to an illustrative embodiment of the present invention. FIG. 1 shows a state where a cover 8 is closed and FIG. 2 shows a state where the cover 8 is opened. This multi-function machine 1 is an MFD (Multi Function Device) having integrally a printer unit 2 on the lower part and a scanner unit 3 on the upper part, and has a printer function, a scanner function, a copy function and a facsimile function. The scanner unit 3 of the multi-function machine 1 corresponds to the image reading apparatus according to illustrative the invention. Accordingly, functions other than the scanner function are optional. For example, the image reading apparatus according to the invention may be a scanner without the printer unit 2, and thus does not have the printer function, the copy function and the facsimile function.

The multi-function machine 1 is mainly connected to a computer (not shown), and in the printer unit 2, performs a process (printer function) of recording the image or document on recording paper based on recording data including image data or document data transmitted from the computer. Also, the multi-function machine 1 performs a process (facsimile function) of transferring image data read by the scanner unit 3 to the communication equipment connected through the telephone line and a process (scanner function) of transferring image data to a storage device such as a hard disk drive (HDD) or a computer. Also, the multi-function machine 1 can perform a so-called original copy process (copy function) of recording the image of the original read by the scanner unit 3 on the recording paper in the printer unit 2 without transmitting or receiving data to or from the computer.

As shown in FIG. 1, the external shape of the multi-function machine 1 is formed as a rectangular parallelepiped in which the lateral width and depth are larger than the height. The printer unit 2 on the lower part of the multi-function machine 1 is formed with an opening 10 in the front. The paper feed tray 11 and the paper output tray 12 are provided in upper and lower sections inside the opening 10. The paper feed tray 11 contains recording sheets of A4 size or less such as B5 size and postcard size, for example. The paper feed tray 11 can be expanded by drawing out a slide tray 13, as needed, to contain recording sheets of legal size, for example. The recording sheet contained in the paper feed tray 11 is fed into the inside of the printer unit 2, whereby a desired image is recorded on the sheet and the sheet is output onto the paper output tray 12.

The printer unit 2 can be an inkjet recording apparatus. That is, the printer unit 2 can record the read image or the image according to print data on the recording paper by discharging ink droplets on the recording paper fed from the paper feed tray 11 by an inkjet method. An inkjet recording head is moved slidingly in the width direction of the recording paper during the recording of the image, while the recording paper is conveyed intermittently at the timing according to this sliding movement.

The printer unit 2 is not limited to an inkjet recording apparatus, but may be a laser printer which deposits toner on an electrostatic latent image formed on the photoconductor using a laser beam and which transfers the toner onto the recording paper, or an image forming apparatus of analog electrophotographic method, for example. Also, the printer unit may be an image forming apparatus such as a thermal printer that performs printing by thermally treating paper to change color, or any other printer unit.

An operation panel 4 for operating the printer unit 2 and/or the scanner unit 3 is provided at the fore side on the upper surface of the multi-function machine 1 and on the upper surface at the front side of the scanner unit 3. The operation panel 4 includes various kinds of operation buttons and a liquid crystal display. The multi-function machine 1 can operate based on an operation instruction input to the operation panel 4. If the multi-function machine 1 is connected to an external computer, the multi-function machine 1 may operate based on an instruction sent from the computer via a printer driver or a scanner driver.

A slot 5 may be provided at the upper left front of the multi-function machine 1. The slot 5 can receive various types of removable storage media, such as memory cards or any other removable media. The image data stored on the storage media inserted into the slot 5 can be read by performing a predetermined operation on the operation panel 4. Information associated with the read image data can be displayed on the liquid crystal display of the operation panel 4. The user can record any image on the recording paper based on the information displayed on the liquid crystal display in the printer unit 2. The slot for receiving removable storage media is illustrative and other configurations for receiving removable storage media may be used instead.

The upper part of the multi-function machine 1 is the scanner unit 3. As shown in FIGS. 1 and 2, the scanner unit 3 has a cover 8 having an ADF (Auto Document Feeder: automatic original conveying device) 7. The cover 8 is attached openably or closably via a hinge 15 on the rear side to a reading section 6 that functions as an FBS (Flatbed Scanner). The reading section 6 serves as a housing for the multi-function machine 1. A platen glass 20 is disposed on the upper surface of the reading section 6 opposed to the cover 8. The cover 8 can be a presser cover, which is configured to press an original against the platen glass 20. Accordingly, when the cover 8 is opened, the platen glass 20 is exposed as the upper surface of the reading section 6, and when the cover 8 is closed, the platen glass 20 is covered.

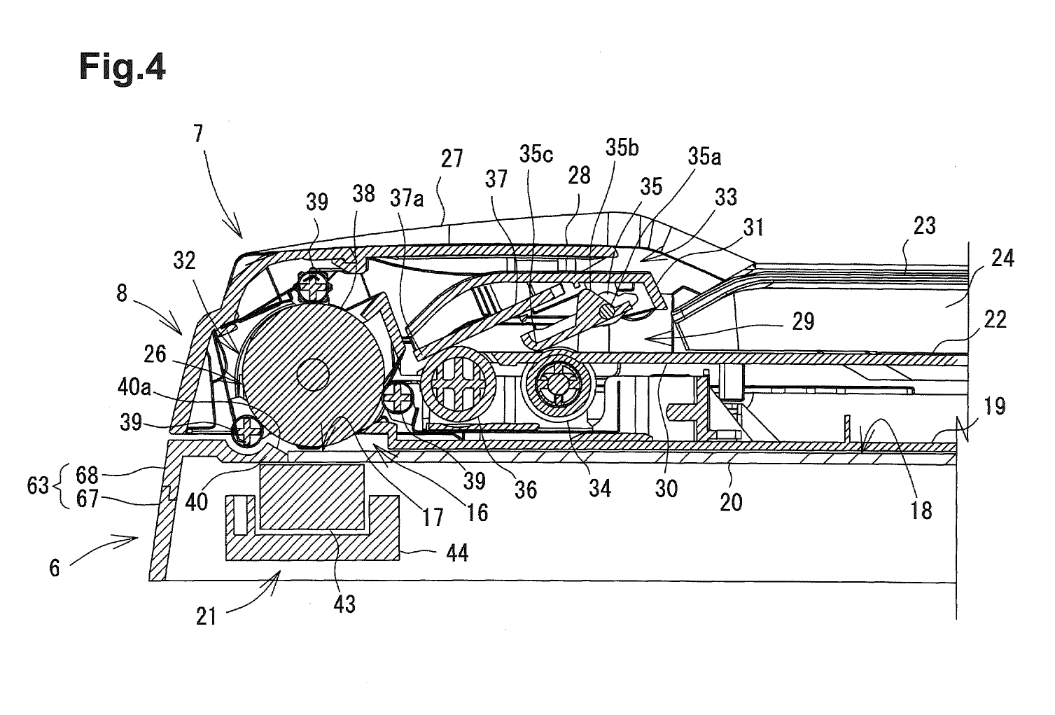

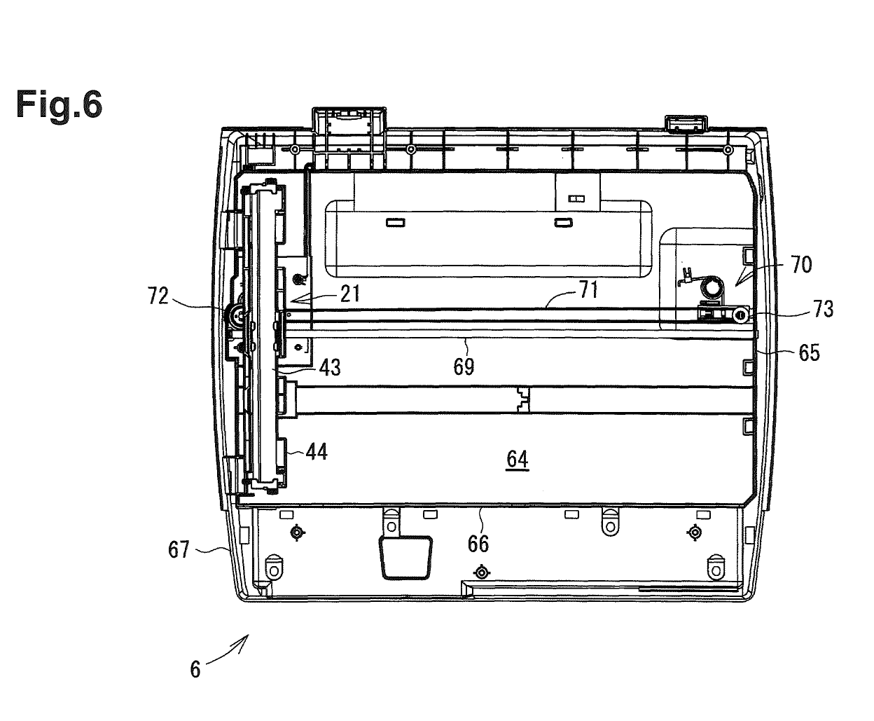

An image reading unit 21 (see FIG. 6) is contained inside the reading section 6 to be opposed to the platen glass 20. When the scanner unit 3 is employed as an FBS, the image reading unit 21 is scanned under the platen glass 20 to read the image of the original placed on the platen glass 20. On the other hand, when the ADF 7 is used, the original is passed through an ADF conveying reading area 17 (see FIGS. 2 and 4) in an original conveying process by the ADF 7, and the image reading unit 21 under the ADF conveying reading area 17 can read the image of the original. The scanner unit 3 and the original image reading operation performed by the scanner unit 3 will be described in detail later.

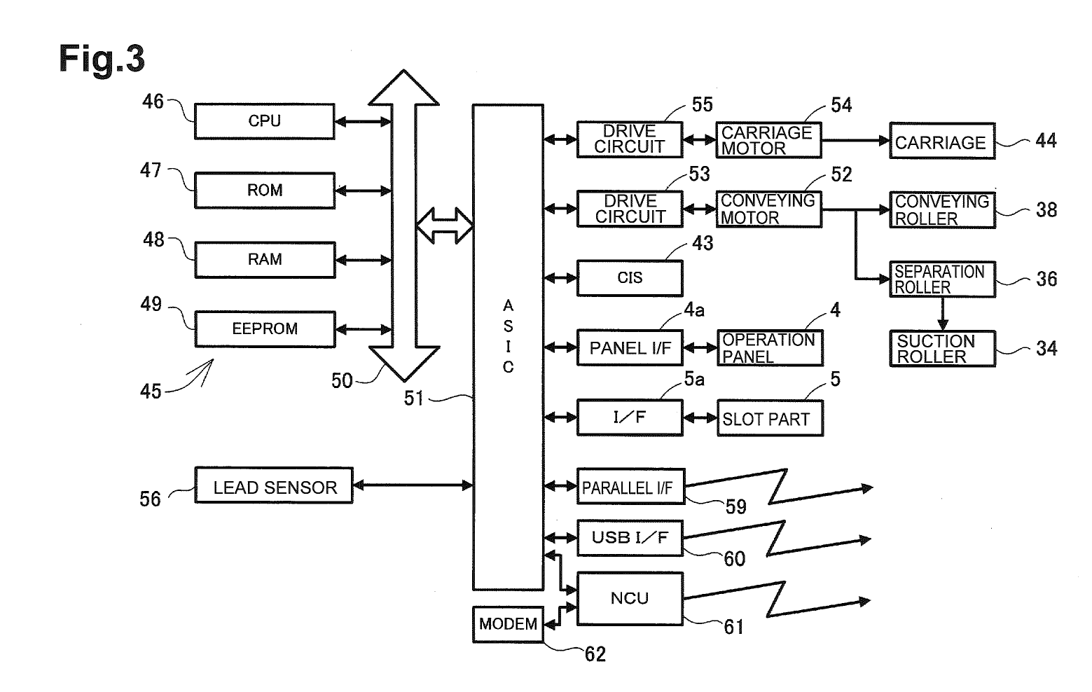

FIG. 3 shows the configuration of an illustrative control unit 45 in the multi-function machine 1. The control unit 45 controls the overall operation of the multi-function machine 1, including the scanner unit 3 and the printer unit 2. However, for brevity, the components of the printer unit 2 are not described herein as being within the knowledge of those skilled in the art, and the components of the printer unit 2 are omitted in FIG. 3. The control unit 45 may be a microcomputer having a CPU (Central Processing Unit) 46, a ROM (Read Only Memory) 47, a RAM (Random Access memory) 48, and an EEPROM (Electrically Erasable and Programmable ROM) 49, which are connected via a bus 50 to an ASIC (Application Specific Integrated Circuit) 51 as shown in FIG. 3.

The ROM 47 can store a program for controlling various operations of the multi-function machine 1. Also, the EEPROM 49 stores various kinds of data used for the processing in accordance with the program. The RAM 48 can be used as a storage area for temporarily storing various kinds of data or an expansion area for data or the program used when the CPU 46 executes the program.

The CPU 46 generally controls the peripheral devices making up the control unit 45 or a controlled device controlled by the control unit 45. The program stored in the ROM 47 or data stored in the RAM 48 or EEPROM 49 is read by the CPU 46, and an operation (e.g., arithmetic) is performed in accordance with the program.

The drive circuits 53 and 55 are connected to the ASIC 51. The ASIC 51 generates a phase excitation signal for exciting a conveying motor 52 and a carriage motor 54 in the scanner unit 3 in accordance with an instruction from the CPU 46. The ASIC 51 applies the signal to the drive circuits 53 and 55 of the conveying motor 52 and the carriage motor 54. Since the drive signal is applied to the drive circuits 53 and 55 to excite the conveying motor 52 and the carriage motor 54, the rotation of each motor can be controlled. Since the rotation of the conveying motor 52 and the carriage motor 55 can be controlled, the conveying roller 38 and the carriage 44 of these motors can be driven. The operation of the conveying roller 38 and the carriage 44 will be described later.

Also, a lead sensor 56 for detecting the original on a conveying passage 26 is connected to the ASIC 51.

Further, a CIS (contact image sensor) 43 for reading the image of the original conveyed on the conveying passage 26 is connected to the ASIC 51. Also, the operation panel 4 for inputting an operation instruction for the multi-function machine 1 and the slot 5 for inserting various types of removable storage media are connected via a panel interface 4a and a slot interface 5a. Further, a parallel interface 59 and a USB interface 60 for transmitting or receiving data via a parallel cable and a USB cable to or from an external apparatus such as a personal computer can be connected. Further, an NCU (Network Control Unit) 61 and a MODEM 62 for implementing the facsimile function are also connected.

The scanner unit 3 and the image reading operation of the scanner unit 3 will be described below in detail.

The cover 8 having the ADF 7 is provided on the top of the scanner unit 3, as shown in FIG. 1. The paper feed tray 22 and the paper output tray 23 are constructed as upper and lower sections on the upper surface of the original presser cover 8, as shown in FIG. 1. The ADF 7 conveys the originals in succession from the paper feed tray 22 via the conveying passage 26 to the paper output tray 23. The image of the original is read in this original conveying process.

The paper feed tray 22 is formed integrally with the upper surface of the original presser cover 8. The original can be placed on the paper feed tray 22 with its top end inserted in the paper feed direction into the ADF 7 in a state where multiple sheets are stacked. Also, the paper feed tray 22 is provided with one pair of original guides 24 spaced in the depth direction of the multi-function machine 1 to be slidable in the depth direction. The original guides 24 protrude from the paper feed tray 22 to regulate the position in the width direction of the originals placed on the paper feed tray 22. If either of the pair of original guides 24 is moved slidingly, the other original guide 24 is also moved slidingly in the opposite direction by a well-known linkage mechanism.

One pair of original guides 24 are formed integrally with the paper output tray 23 spaced upward from the paper feed tray 22. The original output from the ADF 7 is held in a state separated from the originals on the paper feed tray 22 with both sides carried on the paper output tray 23. Because the length of the paper output tray 23 in the paper output direction is shorter than the length of the original, the original is held on the paper feed tray 22 such that the top end of the original in the paper output direction hangs from the paper output tray 23. Accordingly, the top end of the original on the paper output tray 23 in the paper output direction overlaps the rear end of the original on the paper feed tray 22 in the paper feed direction, but the top end of the original on the paper feed tray 22 in the paper feed direction and the rear end of the original on the paper output tray 23 in the paper output direction are held in upper and lower sections by the paper output tray 23, whereby these originals are not mixed. Also, the multi-function machine 1 can be made thinner and smaller by shortening the paper output tray 23 to reduce required space on the original presser cover 8.

A suction chute 29 is formed in a region leading from the paper feed tray 22 to the inside of the ADF 7 (see FIG. 4). When the image of the originals is read using the ADF 7, the originals are placed on the paper feed tray 22 with their top end in the paper feed direction inserted into the suction chute 29.

Also, an original stopper 25 is provided at an end of the paper feed tray 22 on the side where the ADF 7 is not provided, in which the original stopper 25 changes the position to a standing position where it stands from the upper surface of the paper feed tray 22 or a fallen position where it falls integrally with the upper surface of the paper feed tray 22, as shown in FIG. 1. By placing the original stopper 25 in the standing position, the original is restrained by the original stopper 25 and prevented from slipping off the paper feed tray 22 when an original as large as the paper feed tray 22 is output from the ADF 7, for example. In this manner, the area of the paper feed tray 22 can be reduced, and the cover 8 formed integrally with the paper feed tray 22 can be reduced in size. Also, when the original stopper 25 is unnecessary, it is put in the fallen position not to protrude from the cover 8, whereby the size of the multi-function machine 1 in packaging or storage can be made compact, as shown in FIG. 1.

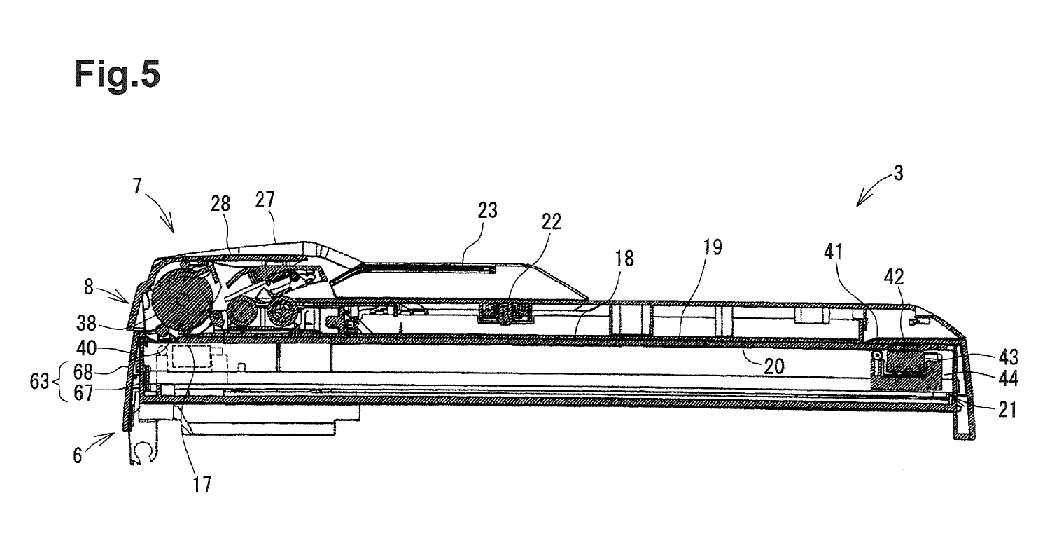

FIG. 4 is a partial cross-sectional view showing the ADF 7. Also, FIG. 5 is a cross-sectional view showing the scanner unit 3. The conveying passage 26 is substantially U-shaped in a cross-sectional view and provided inside the ADF 7, such that the paper feed tray 22 and the paper output tray 23 are connected, as shown in FIG. 4. The conveying passage 26 includes an ADF main body 27 formed integrally with the cover 8 and an ADF cover 28 provided to be freely openable or closable on the ADF main body 27. The suction chute 29 of the ADF 7 includes a passage having a vertical gap of a predetermined width, which is sandwiched between a guide plate 30 formed integrally with the ADF main body 27 to extend the paper feed tray 22 and a partition plate 31 disposed inside the ADF cover 28.

Also, a curved part 32 and a paper output chute 33 are formed as the passages having a gap of predetermined width which are sandwiched between the ADF main body 27, the ADF cover 28 and the partition plate 31.

On the conveying passage 26, a document feeder for conveying the original is disposed. More particularly, the document feeder includes a suction roller 34 and a suction nip 35 pressed against it, a separation roller 36 and a separation nip 37 pressed against it, and a conveying roller 38 and a pinch roller 39 pressed against it, as shown in FIG. 4. Each roller or nip is illustrative, as other document feeders may be employed by changing the number and arrangement of rollers, or substituting the pinch roller for each nip.

The suction roller 34 is provided rotatably in the near center of the suction chute 29 to expose a part of the roller plane from the upper surface of the guide plate 30, as shown in FIG. 4. Also, the separation roller 36 is provided rotatably at a position on the downstream side away from the suction roller 34 in the paper feed direction to expose a part of the roller plane from the upper surface of the guide plate 30 in the same manner. The suction roller 34 and the separation roller 36 are connected to a conveying motor 52 (see FIG. 3), and rotatably driven by a driving force transmitted from the conveying motor 52. Also, the suction roller 34 and the separation roller 36 can have the same diameter and be rotated at the same peripheral speed.

The suction nip 35 is provided swingably in the direction making contact with or separating from the suction roller 34 at the opposite position of the partition plate 31 to the suction roller 34. The suction nip 35 may be a pad having a slightly narrower width than the roller width of the suction roller 34 in the axial direction. A rotation shaft 35a is formed at either side on the upstream side of the suction nip 35 in the paper feed direction. The rotation shaft 35a is supported by a shaft support part 35b formed on the bottom surface of the partition plate 31, so that an end part 35c on the downstream side in the paper feed direction moves forward or backward to make contact with the roller plane of the suction roller 34. Also, the suction nip 35 is resiliently urged downward by a spring member (not shown), and always contacted with the suction roller 34 in a state where the original is not nipped. Instead of the suction nip 35 like the pad, the roller may be employed. However, the pad-like contact member can be made simply and save space, whereby a resilient urging force applied on the contact member is easy to adjust.

The separation nip 37 is provided swingably in the direction making contact with or separating from the separation roller 36 at a position opposite to the partition plate 31 to the separation roller 36. The separation nip 37 may be a pad having a slightly narrower width than the roller width of the separation roller 36 in the axial direction. An end part 37a of the separation nip 37 on the downstream side in the paper feed direction moves forward or backward to make contact with the roller plane of the separation roller 36 around a rotation shaft on the upstream side in the paper feed direction. The separation nip 37 is resiliently urged downward by a spring member not shown), and is pressed against the roller plane of the separation roller 36 in a state where the original is not nipped. Instead of the separation nip 37 like the pad, the roller may be contacted with the separation roller 36. However, the pad-like contact member can be made simply and save space, whereby a resilient urging force applied on the contact member is easy to adjust.

The conveying roller 38 is disposed in the curved part 32 of the conveying passage 26. The outside diameter of the roller surface of the conveying roller 38 faces a part of the curved part 32. The conveying roller 38, like the suction roller 34 and the separation roller 36, is rotatably driven by a driving force transmitted from the conveying motor 52 (see FIG. 3).

The pinch roller 39 is provided at three sites around the conveying roller 38, as shown in FIG. 4. Each pinch roller 39 is freely rotatable and has its shaft resiliently urged by a spring on the ADF main body 27 or the ADF cover 28. Also, each pinch roller 39 can be pressed against the roller surface of the conveying roller 38. Accordingly, if the conveying roller 38 is rotated, the pinch rollers 39 are also caused to rotate. The original is pressed against the conveying roller 38 by these pinch rollers 39 so that a rotational force of the conveying roller 38 can be transmitted to the original.

A presser member 19 is provided on the bottom surface of the cover 8, namely, the surface opposed to the platen glass 20. This presser member 19 is used to press and secure the originals placed on the platen glass 20, and may be composed of a sponge and a plate member. This presser member 19 has a single color such as white over the entire area to produce a stable reflected light from the original. An opening 16 (see FIGS. 2 and 4) is formed at an end part on the bottom surface of the cover 8 near the vertically lower part of the conveying roller 38. This opening 16 communicates with the conveying passage 26. The opening 16 is used to expose the original from the conveying passage 26 to the ADF conveying reading area 17 (see FIGS. 2 and 4) on the platen glass 20 in reading the image of the original using the ADF 7, and return the original to the conveying passage 26 again after reading the image of the original in the ADF conveying reading area 17.

The paper output chute 33 is formed on the most downstream side of the conveying roller 38 in the paper feed direction. The paper output chute 33 is formed between the ADF cover 28 and the partition plate 31 to be successive to the curved part 32 of the conveying passage 26 composed of the inside surface of the ADF cover 28 and the conveying roller 38. Accordingly, the original supplied from the paper feed tray 22 to the conveying passage 26 is passed through the suction chute 29, the opening 16, the curved part 32, and the paper output chute 33 in succession and output onto the paper output tray 23.

The scanner unit 3 includes a reading section 6. This reading section 6 can serve as the housing of the multi-function machine 1. A main body frame 63 of the reading section 6 includes a lower frame 67 like a vessel with the upper surface opened and an upper cover 68 having an opening on the upper surface, as shown in FIGS. 4 and 5. The main body frame 63 is constructed by fitting the upper cover 68 onto the lower frame 67. The platen glass 20 is attached on the upper cover 68 to be exposed through the opening.

The entire surface area 18 of the platen glass 20 includes a plane on which the original is placed when the scanner unit 3 is employed as the FBS. That is, the entire surface area 18 of the platen glass 20 is a scannable range of the image reading unit 21 in reading the image of the original with the FBS. In other words, it is a range where the image of the original placed on the platen glass 20 is read by the image reading unit 21. This entire surface area 18 corresponds to the FBS reading area according to aspects of the invention. In the following, the entire surface area of the platen glass 20 is called an FBS reading area 18.

One end of the platen glass 20 on the side where the ADF 7 is provided extends up to the lower part of the conveying roller 38, as shown in FIGS. 2, 4 and 5. An area on the platen glass 20 extending in the depth direction (direction perpendicular to the page of FIG. 4) of the apparatus corresponding to the lower part of the conveying roller 38, namely, an area surrounded like a rectangle by the broken line in FIG. 2, is a reading area (hereinafter referred to as an “ADF conveying reading area”) 17 for reading the image using the ADF 7. This ADF conveying reading area 17 includes a reading position in which the image of the original can be read, while conveying the original using the ADF 7. The ADF conveying reading area 17 extends in the depth direction (direction perpendicular to the page of FIG. 4) of the multi-function machine 1, corresponding to the length of the image reading unit 21 in the main scanning direction, as shown in FIG. 2.

In the multi-function machine 1, though the ADF conveying reading area 17 and the FBS reading area 18 are set up on the surface of the platen glass 20 as above described, they are not partitioned by a physical member. That is, the ADF conveying reading area 17 and the FBS reading area 18 are provided on the same plane of the platen glass 20, and a partial area of the FBS reading area 18 is used as the ADF conveying reading area 17. Accordingly, the width direction of the apparatus can be reduced because there is no member for partitioning the ADF conveying reading area 17 and the FBS reading area 18 like the conventional apparatus.

A pickup member 40 (corresponding to the guide member) is provided outside one end of the platen glass 20 in the width direction (sub-scanning direction), namely, outside the end part of the platen glass 20 on the side where the ADF 7 is provided, as shown in FIGS. 4 and 5. The pickup member 40 plays a role of picking up the original passing through the ADF conveying reading area 17 and guiding the original through the opening 16 to the conveying passage 26. The pickup member 40 is made of synthetic resin and formed integrally with the upper cover 68 of the main body frame 63. The pickup member 40 is provided with an inclined face 40a that is inclined in the outwardly upper direction at the end part of the platen glass 20. The pickup member is positioned so that the lower end of the inclined face 40a may be slightly lower than the upper surface of the platen glass 20 at the junction with the platen glass 20. Accordingly, the top end of the original passing through the ADF conveying reading area 17 is led on the inclined face 40a smoothly without being trapped and guided into the opening 16 located above.

Also, a locating member 41 is disposed at one end of the platen glass 20 where the ADF 7 is not provided, namely, an end opposite to the end where the pickup member 40 is provided, as shown in FIGS. 2 and 5. The locating member 41 may be a plate-like member extending in the depth direction of the multi-function machine 1, and provided on the upper surface of the platen glass 20. On the upper surface of the locating member 41, a mark indicating the end point of various sizes such as A4 (210□297 mm), B5 (182□257 mm) and so on is denoted on the basis of the central point of the locating member 41, so that the user may easily grasp the size of the original in the main scanning direction when the original is placed in the FBS reading area 18 of the platen glass 20. By making one end of the original abut against the locating member 41, one end of the original placed in the FBS reading area 18 is held, so that the position where the original is placed in the main scanning direction is established. The positioning of the original in the sub-scanning direction is made by making one end of the original abut against the locating member 41 and aligning both ends in its width direction with the end points as indicated by the locating member 41.

In this illustrative embodiment, the locating member 41 is formed integrally with the upper cover 68 of the main body frame 63 on the reading section 6. The locating member 41 can be part of the upper cover 68. In another example, the locating member 41 may include another member from the upper cover 68, and be attached to the upper surface of the upper cover 68 by adhesives or contact fitting.

A reference color member 42 (corresponding to a shading correction reference member) used to make a shading correction to the image signal is provided under the locating member 41, as shown in FIG. 5. Specifically, the reference color member 42 is interposed between the bottom surface of the locating member 41 and the upper surface of the platen glass 20. That is, the reference color member 42 is configured to be sandwiched between the locating member 41 and the platen glass 20. The reference color member 42 is a slender band having a small thickness and a predetermined color, and typically may be a tape or thin strip of the predetermined color. Or the predetermined color may be directly applied on the bottom surface of the locating member 41. In this case, an area applied with the predetermined color corresponds to the shading correction reference member.

The reference color member 42 may have a black reference area and a white reference area. These reference areas may be bands parallel to the depth direction of the multi-function machine 1, namely parallel to the positioning direction of the original by the locating member 41. Specifically, the black reference area and the white reference area are adjacent to the direction orthogonal to the positioning direction of the original. Accordingly, the reference color member 42 may be colored as a stripe of black and white extending in the positioning direction of the original. The black reference area may be set closer to the center of the platen glass 20 than the white reference area. These reference areas are not limited to black and white, but may include various colors such as red, blue and green, middle gradation colors having different lightness, and other colors or patterns. Of course, the number of colors in the reference area is not limited to white and black, and may be more than two. Also, a reference area having multiple patterns such as meshing, stripes and so on may be employed. Briefly, the reference area can have any of the colors or patterns as long as the boundary position between the original and the reference area can be determined by an output signal of the CIS 43 in the image reading unit 21.

In this embodiment, the home position of the image reading unit 21 is set under the locating member 41. This home position means the position at which the image reading unit 21 is set when the image reading operation is not performed. Since the home position is set under the locating member 41, the initial motion in reading the original placed on the platen glass 20 can be performed quickly. The home position is not required to be directly under the locating member 41.

The image reading unit 21 is provided inside the reading section 6 to oppose the platen glass 20 and to move in the width direction (lateral direction of FIGS. 5 and 6) of the multi-function machine 1, as shown in FIGS. 4 to 6. Herein, FIG. 6 is a plan view showing the reading section 6. For purposes of illustration, the upper cover 68 and the cover 8 are omitted in FIG. 6.

The main body frame 63 that is the housing of the reading section 6 may be made of synthetic resin. The image reading unit 21 is disposed within the lower frame 67 of the main body frame 63, as shown in FIG. 6. The lower frame 67 may be made by integrally molding a base part 64 including a bottom plate, a side wall 65 extending from the periphery of the base part 64, a plate 66 for separating a portion where the image reading unit 21 is disposed and a portion where the base plate of the operation panel 4 is disposed. Also, the lower frame 67 is provided with a support rib for supporting the platen glass 20, a boss part for screwing various members, and a through hole for the electrical wiring. It will be appreciated by one skilled in the art that the main body fame 63 and lower frame 67 can be appropriately designed in accordance with the reading section 6, and as such are not described in detail.

The image reading unit 21 has a CIS (Contact Image Sensor) 43 and a carriage 44. The CIS 43 is a line image sensor in which the main scanning direction is the depth direction (vertical direction in FIG. 6) of the multi-function machine 1. More particularly, the CIS 43 is a so-called contact type line image sensor in which the light emitted from a light source is applied to the platen glass 20 on which the original is placed, reflected light from the original, the presser member 19 or the reference color member 42 is directed via the lens to the light receiving element (photoelectric conversion element), and the light receiving element outputs an electric signal according to the intensity (brightness or light quantity) of the reflected light. The sub-scanning direction is the direction orthogonal to the main scanning direction and parallel to the platen glass 20.

The CIS 43 is mounted on the carriage 44, and moves under the platen glass 20. The carriage 44 is fitted around a guide shaft 69 installed over the width direction of the lower frame 67, namely, the width direction of the multi-function machine 1. The carriage 44 is driven by a belt drive mechanism 70 and moved to slide on the guide shaft 69. The carriage 44 is moved along the guide shaft 69 to which the CIS 43 is mounted so that the CIS moves parallel to the platen glass 20.

The belt drive mechanism 70 has a circular annular timing belt 71 with teeth inside stretched between a drive pulley 72 and a follower pulley 73 provided at both ends in the width direction. A driving force is inputted from the carriage motor 54 (see FIG. 3) to the shaft of the drive pulley 72. The timing belt 71 is moved peripherally along with the rotation of the drive pulley 72. A stepping motor may be employed as the carriage motor 54. Accordingly, the distance which the image reading unit 21 moves and the conveying position of the image reading unit 21 can be controlled by the belt drive mechanism 70 and can be measured by monitoring the number of steps for the carriage motor 54. Alternatively, the timing belt 71 may be a driving belt with both ends fixed to the carriage 44.

In this embodiment, an example in which the image reading unit 21 including the CIS 43 is applied to the scanner unit 3 will be described below. Alternatively, the image reading unit including an image sensor such as a CCD (Charge Coupled Device) or a CMOS (Complementary Metal-Oxide Semiconductor) or any other image reading unit may be applied to the scanner unit 3.

When the scanner unit 3 is employed in an FBS operation, the original is placed in the FBS reading area 18 of the platen glass 20 by opening the cover 8, and then the original is fixed on the platen glass 20 by closing the cover 8. At this time, the image reading unit 21 waits at the home position set under the locating member 41 in a state where no read instruction is inputted.

If a read instruction is inputted by, for example, pressing the start button on the operation panel 4, shading correction is carried out before reading the image of the original to correct unevenness in the output value of the CIS 43 due to, for example, uneven light quantity from the light source, a defect in the lens, and a precision error in the light receiving element,. Specifically, the belt drive mechanism 70 is activated, and the image reading unit 21 is moved up to the image reading position in the white reference area. Next, the emission amount of the light source is increased gradually, starting from a sufficiently small light quantity at that position, and the light quantity of the light source when the reflected light quantity from the white reference area of the reference color member 42 reaches a preset reference light quantity is stored as a light quantity adjusted value in the RAM 48.

After adjusting the light quantity, the reflected light from the white reference area is acquired with the light quantity after adjustment, and stored as white level data in the RAM 48. Further, the reflected light from the black reference area is acquired and stored as black level data in the RAM 48. At this time, the image reading unit 21 moves while receiving the reflected light so as to cross the boundary between the white reference area and the black reference area. Then, the boundary position is detected, based on a change in the reflected light quantity from the reference color member 42. The distance traveled and the current position of the image reading unit 21 can be measured based on the number of steps of the carriage motor 54 from the detected boundary position.

The white level data and the black level data are acquired over the entire area of the CIS 43 in the main scanning direction. However, the output value outputted as image data from the CIS 43 can become uneven due to uneven light quantity of the light source, a defect in the lens, and a precision error in the light receiving element as described above. An uneven output value can be smoothed by removing or adding a deviation (difference from the average value) of the output value of the CIS 43. Such a smoothing process is performed by the CPU 46 of the control unit 45, and called a shading correction process. Needless to say, various shading correction methods may be applied in place of the above-described method.

If the shading correction is made, the image reading unit 21 is returned to the home position set under the locating member 41. Thereafter, the image reading unit 21 is moved under the platen glass 20 from the home position by sliding along the guide shaft 69 to read the image of the original. At this time, the CIS 43 of the image reading unit 21 applies light to the original placed on the platen glass 20 while moving, as well as receives the reflected light from the original to convert the received light into an electrical signal. Such a converted electrical signal is read as image data of the original.

If the image reading unit 21 is moved a predetermined distance based on the document size, it is determined that the image reading has ended. At this time, the image reading unit 21 is returned to the home position. Of course, the timing of returning the image reading unit 21 to the home position can be appropriately set up. Accordingly, the image reading unit 21 may be returned to the home position when the next image reading instruction is inputted, or when a predetermined time has passed from the end of image reading, but not immediately after the image reading has ended.

On the other hand, in the ADF scanning operation, if a read instruction is inputted by pressing the start button on the operation panel 4, the image reading unit 21 is moved from the home position to the read position (see FIG. 4) under the ADF conveying reading area 17 after shading correction has been performed, and rests at that position. Also, the original placed on the paper feed tray 22 is fed into the conveying passage 26 by the suction roller 34 and the separation roller 36 in parallel to the moving operation of the image reading unit 21. The original fed into the conveying passage 26 is sandwiched between the conveying roller 38 and the nip roller 39, and conveyed downstream in the paper feed direction.

In the process in which the original is conveyed by the conveying roller 38, the original is once output from the conveying passage 26 through the opening 16 provided on the bottom surface of the original presser cover 8, and conveyed toward the ADF conveying reading area 17 on the platen glass 20. At this time, while the original is passed through the ADF conveying reading area 17, its image is read by the image reading unit 21 waiting below the reading area 17. For the original passed on the ADF conveying reading area 17 and conveyed towards the end part of the platen glass 20, the top end of the original abuts against the inclined face 40a of the pickup member 40, so that the direction of the top end of the original is directed upward. Thereby, the original is returned to the conveying passage 26 via the opening 16 again. The original returned to the conveying passage 26 is conveyed to be bent upward by the curved part 32, and output via the paper output chute 33 onto the paper output tray 23 disposed above the paper feed tray 22. If the image reading using the ADF 7 ends, the image reading unit 21 is returned to the home position, but this return timing is arbitrarily set.

In the multi-function machine 1 as described above, since the pickup member 40 is provided at one end of the platen glass 20 in the sub-scanning direction, and the locating member 41 is provided at another end, the entire area of the platen glass 20 can be used as the FBS reading area 18, and a portion of the FBS reading area 18 can also be used as the ADF conveying reading area 17. Further, since the scanner unit 3 is provided with the locating member 41, the original placed in the FBS reading area 18 can be easily located.

The above embodiments and aspects are illustrative, and it will be appreciated by one of ordinary skill in the art that various modifications may be appropriately made without departing from the spirit or scope of the invention.

What is claimed is:

1. An image reading apparatus comprising a platen glass having a common reading area in which ADF scanning and FBS operation are configured to be performed.

2. The image reading apparatus according to claim 1, further comprising:
a document feeder for conveying an original to the common reading area for ADF scanning; and
an image reader configured to read, in an ADF scanning operation, an image of the original in the common reading area and conveyed to the common reading area by the document feeder, and configured to read, in an FBS operation, an image of an original in the common reading area on the platen glass.

3. The image reading apparatus according to claim 1, further comprising:
a guide member, provided at a first end of the platen glass, configured to pick up an original document passing over the common reading area during ADF scanning; and
a locating member, provided at a second end opposite to the first end of the platen glass, for positioning a stationary original during FBS operation.

4. The image reading apparatus according to claim 3, further comprising a shading correction reference member extending in a main scanning direction under the locating member.

5. The image reading apparatus according to claim 4, wherein the locating member is provided on an upper surface of the platen glass, and the shading correction reference member is provided between a bottom surface of the locating member and the upper surface of said platen glass.

6. The image reading apparatus according to claim 2, wherein a home position of the image reader is located under the locating member.

7. The image reading apparatus according to claim 6, wherein said home position and said locating member are located at an edge of said platen glass.

8. The image reading apparatus according to claim 3, wherein said locating member is integrally formed with a main body frame of said apparatus.

9. An image scanning method, comprising:
using a first area of a platen glass for both automatic document feeder scanning and stationary document flat bed scanning; and
using a second area of said platen glass for stationary flat bed scanning.

10. The method of claim 9, further comprising placing an image reader at a home position when not scanning, wherein said home position is located at an opposite end of said glass from said first area.

11. The method of claim 9, further comprising:
holding an image reader at a position under said first area to perform ADF scanning; and
moving said image reader across said position under said first area to perform stationary flat bed scanning.

12. The method of claim 9, wherein said second area of said platen glass is used only for stationary flat bed scanning.

13. The method of claim 9, further comprising:
performing stationary flat bed scanning by passing an image reader underneath both said first and second areas; and
performing automatic document feeder scanning by holding said image reader at a fixed location underneath said first area.

14. An image reading apparatus comprising:
a platen glass;
an image reader positioned under said platen glass; and
a circuit configured to control a motor to hold said image reader at a fixed position under a first area of said platen glass during ADF scanning, and to move said image reader across said first area during stationary document flat bed scanning.

15. The image reading apparatus of claim 14, further comprising:
a document positioning member positioned at an end of said platen glass and configured to hold an original document in place during flat bed scanning.

16. The image reading apparatus of claim 15, further comprising a home position for said image reader when said image reader is not performing ADF or stationary document flat bed scanning, said home position being located under said document positioning member.

17. The image reading apparatus of claim 15, wherein said document positioning member is integrally formed with a main body frame of said apparatus.

18. The image reading apparatus of claim 14, wherein said platen glass includes a first common area configured to be used for both ADF and stationary document flat bed scanning; and a second area configured to be used for stationary document flat bed scanning.

19. The image reading apparatus of claim 18, wherein said apparatus does not include any partition on said glass separating said first and second areas.

20. The image reading apparatus of claim 14, wherein said apparatus is a multi-function device configured to scan documents and print documents.
